(19) United States
(12) Patent Application Publication
(10) Pub. No.: US 2024/0266701 A1
(43) Pub. Date: Aug. 8, 2024

(54) DEHUMIDIFICATION SYSTEM FOR BATTERY PACK WITH DESICCANT RECONDITIONING

(71) Applicant: GM GLOBAL TECHNOLOGY OPERATIONS LLC, Detroit, MI (US)

(72) Inventors: Konrad M. Brown, Allen Park, MI (US); Vicente Domenech-Llopis, Rochester Hills, MI (US)

(73) Assignee: GM GLOBAL TECHNOLOGY OPERATIONS LLC, Detroit, MI (US)

(21) Appl. No.: 18/166,088

(22) Filed: Feb. 8, 2023

(51) Int. Cl. H01M 50/673; H01M 10/615; H01M 50/342

(52) U.S. Cl. CPC H01M 50/673; H01M 10/615; H01M 50/342

(57) ABSTRACT

A system for managing dehumidification in a battery pack having a plurality of battery modules includes a casing is adapted to house the plurality of battery modules. The casing has at least one cavity with a dehumidification unit being at least partially positioned within the cavity. The dehumidification unit includes a desiccant. A heating element is positioned in proximity to and adapted to selectively heat the desiccant. The system includes a control unit having a processor and tangible, non-transitory memory on which instructions are recorded. The control unit is adapted to control the heating element. The desiccant is adapted to collect moisture during a collection phase of dehumidification and the heating element is adapted to dry the desiccant during a reconditioning phase of the dehumidification.

### INTRODUCTION

The present disclosure relates generally to a system and method of managing dehumidification in a battery pack. The use of mobile platforms employing a rechargeable energy source, both as an exclusive source of energy and a non-exclusive source of energy, has greatly increased over the last few years. A rechargeable energy storage device with battery packs may store and release electrochemical energy as needed during a given operating mode. The electrochemical energy may be employed for propulsion, heating or cooling a cabin compartment, powering vehicle accessories and other uses. A battery pack may absorb moisture through various sources, such as for example, holes in the casing. The presence of moisture may affect battery performance and battery life.

### SUMMARY

Disclosed herein is a system for managing dehumidification in a battery pack having a plurality of battery modules. A casing is adapted to house the plurality of battery modules. The casing has at least one cavity, with a dehumidification unit being at least partially positioned within the cavity. The dehumidification unit includes a desiccant. A heating element is positioned in proximity to and adapted to selectively heat the desiccant. The system includes a control unit having a processor and tangible, non-transitory memory on which instructions are recorded. The desiccant is adapted to collect moisture during a collection phase of dehumidification and the heating element is adapted to dry the desiccant during a reconditioning phase of the dehumidification. The control unit is adapted to activate and/or control the heating element.

In some embodiments, the desiccant is composed of silica gel. An internal hygrometer may be adapted to obtain hygrometer data pertaining to humidity level inside the casing. The control unit may be adapted to activate the heating element when a plurality of conditions may be met, including the hygrometer data being at or above a respective threshold. In some embodiments, the plurality of conditions includes an ambient temperature being above the respective threshold. The plurality of conditions may include a temperature of the battery pack being above the respective threshold and/or a state of charge of the battery pack being below the respective threshold.

An external hygrometer may be positioned outside the casing. The control unit may be adapted to adjust respective parameters of the heating element based on data obtained by the external hygrometer. An interior vent cover and an exterior vent cover may be located at an interior end and an exterior end, respectively, of the at least one cavity. The interior vent cover and the exterior vent respectively include a plurality of spaced apart gaps.

In some embodiments, an internal louver is located between the desiccant and the interior vent cover. An external louver is located between the desiccant and the exterior vent cover, the internal louver and the external louver having a respective closed state and a respective open state. The internal louver may be actuated to the respective closed state during the reconditioning phase and the external louver may be actuated to the respective closed state during the collection phase.

A breathable membrane may be positioned between the exterior vent cover and the desiccant. The breathable membrane may be configured to permit water vapor to escape from the casing and prevent liquid from entering the casing. In some embodiments, the external louver and the internal louver are configured to be actuated through a diffusion gradient. The external louver and the internal louver may be driven by a single actuator, the external louver and the internal louver being configured to move in unison. The single actuator may include a piezo-electric actuated diaphragm and/or an active solenoid.

Disclosed herein is a method of managing dehumidification in a battery pack having a plurality of battery modules and a control unit with a processor and tangible, non-transitory memory on which instructions are recorded. The method includes housing the plurality of battery modules in a casing with at least one cavity. The method includes positioning a dehumidification unit within the at least one cavity, the dehumidification unit including a desiccant. The method includes positioning a heating element in proximity to the desiccant and selectively heating the desiccant via the heating element, the heating element being adjustable via the control unit. The method includes collecting moisture from the plurality of battery modules in the desiccant during a collection phase of dehumidification and drying out the desiccant during a reconditioning phase of the dehumidification, via the heating element.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic fragmentary diagram of a system for managing dehumidification in a battery pack;

FIG. 2 is a schematic fragmentary enlarged diagram of an example dehumidification unit that may be employed in the battery pack of FIG. 1; and

FIG. 3 is a flowchart for a method of managing dehumidification in a battery pack.

Representative embodiments of this disclosure are shown by way of non-limiting example in the drawings and are described in additional detail below. It should be understood, however, that the novel aspects of this disclosure are not limited to the particular forms illustrated in the above-enumerated drawings. Rather, the disclosure is to cover modifications, equivalents, combinations, sub-combinations, permutations, groupings, and alternatives falling within the scope of this disclosure as encompassed, for instance, by the appended claims.

### DETAILED DESCRIPTION

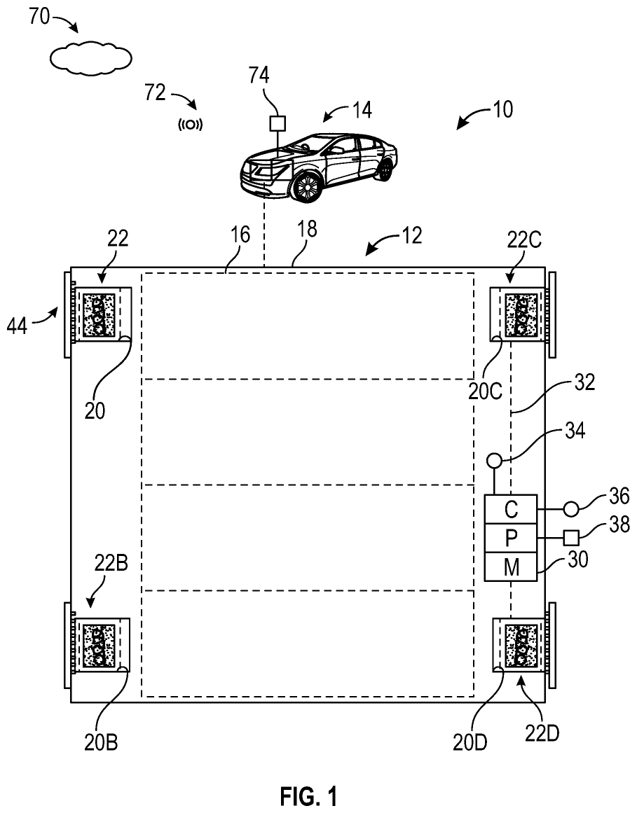

Referring to the drawings, wherein like reference numbers refer to like components, FIG. 1 schematically illustrates a system 10 for managing dehumidification in a rechargeable energy storage unit or battery pack 12 which may be installed in a vehicle 14. The battery pack 12 includes a plurality of battery modules 16 housed in a casing 18. The vehicle 14 may include, but is not limited to, a passenger vehicle, sport utility vehicle, light truck, heavy duty vehicle, minivan, bus, transit vehicle, bicycle, moving robot, farm implement (e.g., tractor), sports-related equipment (e.g., golf cart), boat, plane, train or another moving platform. The vehicle 14 may be an electric vehicle, which may be purely electric or hybrid/partially electric. The vehicle 14 may take many different forms and have additional components. It is understood that the FIGS. are not drawn to scale.

The casing 18 has at least one pocket or cavity 20 with a dehumidification unit 22 being at least partially positioned within the cavity 20. In the embodiment shown, the casing 18 includes three additional cavities 20B, 20C, 20D each filled with a respective dehumidification unit 22B, 22C, 22D. However, it is understood that the number of cavities and dehumidification units may be varied based on the application at hand.

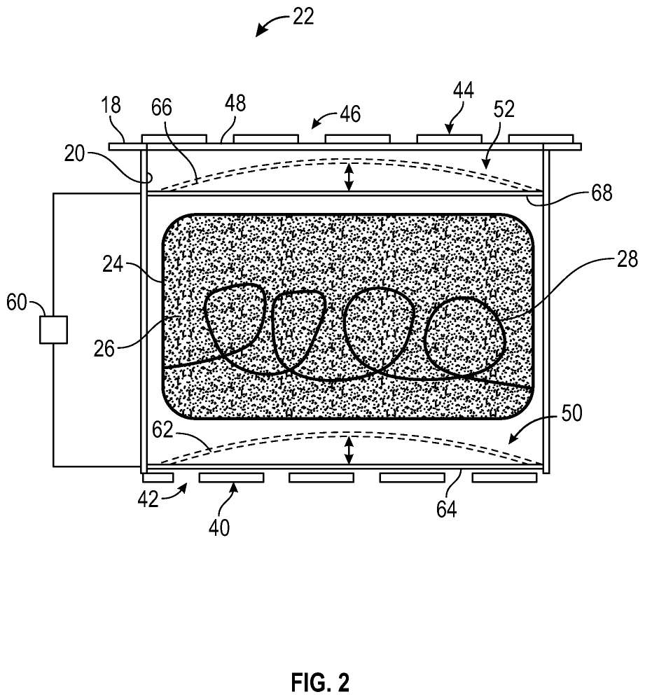

A schematic enlarged representation of an example dehumidification unit 22 is shown in FIG. 2. Referring to FIGS. 1-2, the dehumidification unit 22 includes a desiccant enclosure 24 enclosing a desiccant 26. The system 10 provides a permanent integrated system for dehumidification of the rechargeable energy storage unit 12. The dehumidification unit 22 combines a reusable desiccant with an automated system that determines when to recondition the desiccant 26. The desiccant 26 is a hygroscopic substance used as a drying agent. In one example, the desiccant 26 is composed of silica gel. The desiccant 26 may include activated charcoal, calcium sulfate, calcium chloride, molecular sieves such as zeolites and other materials available to those skilled in the art.

Previous methods for moisture control are generally of the one-time use variety. In other words. in previous methods where once the moisture is absorbed, it is simply contained, and there is a limit to the amount of moisture that may be absorbed in the lifetime of the desiccant 26, unless a service replacement to the absorbent material is performed. Additionally, drying out a desiccant 26 is generally a manual process that requires an operator to move the desiccant to another location for a specific duration of time such that the absorbed moisture is not released back into its original environment during the drying process. In contrast, the system 10 provides a means to remove moisture from the battery pack 12 in a way that is reusable and does not require service for normal operation.

Referring to FIG. 2, a heating element 28 is positioned in proximity to and adapted to selectively heat the desiccant 26. For example, the heating element 28 may be a nichrome wire utilizing electrical resistance heating. Other types of heating elements may be employed. As described below, the dehumidification unit 22 allows the collection of moisture from inside the casing 18 or electric vehicle battery case and periodically expels that moisture outside the casing 18. The system 10 is reusable so that it may continue to function for the lifespan of the battery pack 12.

Referring to FIG. 1, the system 10 includes a control unit 30 having an integrated controller C with at least one processor P and at least one memory M (or non-transitory, tangible computer readable medium) on which instructions may be recorded for selectively executing method 100 for managing the dehumidification. The memory M can store control unit-executable instruction sets, and the processor P can execute the control unit-executable instruction sets stored in the memory M. Referring to FIG. 1, the heating element 28 may be connected to the control unit 30 via powerlines 32. The control unit 30 is adapted to activate and/or control the heating element 28.

For execution of the method 100, the control unit 30 may receive input from various sensors, such as one or more hygrometers which measure the humidity level in air or in a gas. Referring to FIG. 1, the system 10 may include an internal hygrometer 34 positioned inside the casing 18 for measuring the humidity of the air inside the casing 18. The sensors may include an external hygrometer 36 positioned outside the casing 18 for measuring the humidity of the ambient air. The control unit 30 may be adapted to adjust respective parameters of the dehumidification based on data obtained by the internal hygrometer 34 and/or external hygrometer 36.

Referring to FIG. 1, the control unit 30 may receive input from a reconditioning timer 38. The reconditioning timer 38 indicates when the next reconditioning is due. The battery pack 12 may be regularly scheduled for reconditioning via the reconditioning phase, for example, every two weeks etc.

Referring to FIG. 2, the dehumidification unit 22 includes an interior vent cover 40 located at an interior end 42 of the cavity 20. The interior vent cover 40 includes a plurality of spaced apart gaps. An exterior vent cover 44 (shown in FIGS. 1-2) is located at an exterior end 46 of the cavity 20. The exterior vent cover 44 includes a plurality of spaced apart gaps.

Referring to FIG. 2, a breathable membrane 48 is positioned between the exterior vent cover 44 and the desiccant 26. The breathable membrane 48 is configured to permit water vapor to escape from the casing 18 and prevent liquid from entering the casing 18. In one example, the breathable membrane 48 is composed of Gore-Tex.

Referring to FIG. 2, an internal louver 50 is located between the desiccant 26 and the interior vent cover 40. An external louver 52 is located between the desiccant 26 and the exterior vent cover 44. The internal louver 50 and the external louver 52 are ventilation devices that allow air to pass through them, respectively, while keeping out liquid and solid elements. The liquid and solid elements may include water, dirt, debris etc. It is understood that other configurations may be employed.

Referring to FIG. 2, the internal louver 50 has a respective open state 62 (in dashed lines) and a respective closed state 64 (in solid lines). Similarly, the external louver 52 is in a respective open state 66 (in dashed lines) and a respective closed state 68 (in solid lines). The shape, location, and orientation of the louvers may be selected to promote expulsion of moisture in the desired direction (e.g., through the exterior vent cover 44) rather than back into the casing 18. For example, the internal louver 50 and/or the external louver 52 may be oriented in an upward manner such that a buoyancy gradient would drive less dense, warm, moist air into denser, cold air. In the example shown, the internal louver 50 and the external louver 52 are dome shaped in their respective open states 62, 66.

The internal louver 50 and the external louver 52 may be configured to move in unison through the actions of an actuation mechanism 60. The actuation mechanism 60 may be a single mechanism, or it may be a dually operated mechanism. In another embodiment, the internal louver 50 and the external louver 52 are driven to move through the actions of a diffusion gradient.

Referring to FIG. 2, in the collection phase of dehumidification, the heating element 28 is turned OFF, the internal louver 50 is in the open state 62 and the external louver 52 is in a closed state 68. Since the external louver 52 is in the closed state 68, moisture in the environment is blocked from entering the casing 18. The internal louver 50 is in the open state 62 allowing moisture from within the casing 18 to enter the dehumidification unit 22 and be absorbed by the desiccant 26.

In the reconditioning phase of dehumidification, the heating element 28 is turned ON, the external louver 52 is in the open state 66 and the internal louver 50 is in a closed state 64. The internal louver 50 being in the closed state 64 prevents water vapor from going back into the casing 18 during the reconditioning phase. As the desiccant 26 is heated and dried out, the released moisture exits from the casing 18 and enters the environment through the external louver 52, which is in the open state 62. Once dried, the desiccant 26 is reconditioned to continue to absorb moisture.

The actuation mechanism 60 may incorporate a piezoelectric actuator that converts an electrical signal into a precisely controlled physical displacement. The actuation mechanism 60 may incorporate an active solenoid. Other types of actuation mechanisms available to those skilled in the art may be employed. In some examples, the external louver 52 and the internal louver 50 are composed of a shape memory alloy which undergoes reversible deformation through application of heat.

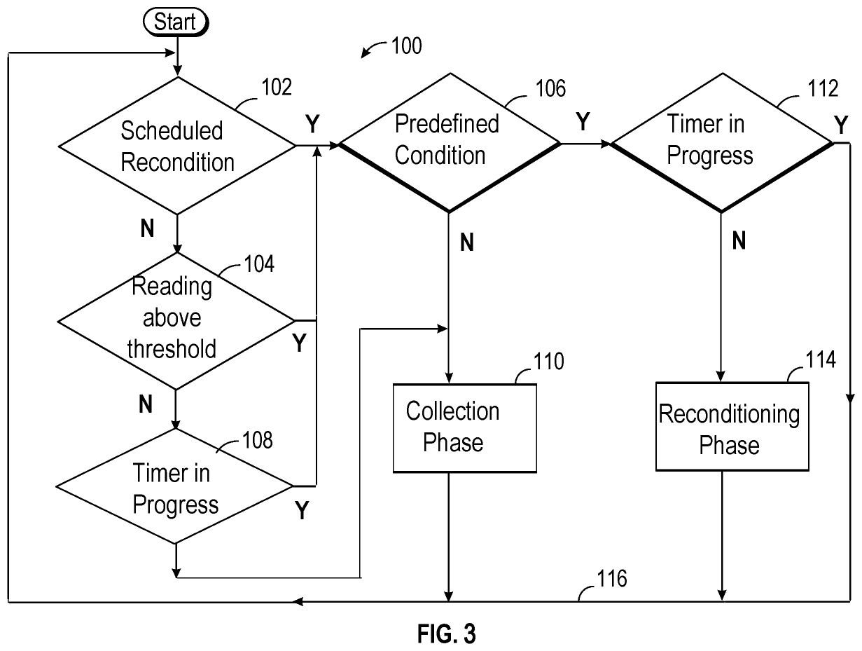

Referring now to FIG. 3, a flowchart of an example method 100 of operation of system 10 is shown. Method 100 need not be applied in the specific order recited herein. Furthermore, it is to be understood that some blocks may be eliminated. In some embodiments, method 100 may be embodied as computer-readable code or stored instructions and may be at least partially executable by the control unit 30.

Beginning at block 102 of FIG. 3, the method 100 includes determining if the battery pack 12 is currently scheduled, timewise, for reconditioning. If the battery pack 12 is not scheduled for reconditioning (block 102=NO), the method 100 advances to block 104 where the control unit 30 determines whether the hygrometer data (readings obtained by the internal hygrometer 34 and/or external hygrometer 36) is at or above a predetermined threshold.

If the battery pack 12 is scheduled for reconditioning (block 102=YES), the method 100 advances to block 106. If the hygrometer data is at or above the predetermined threshold (block 104=YES), the method 100 advances to block 106 as well. In block 106, the control unit 30 determines if a number of predefined conditions for reconditioning have been met. The predefined conditions may include the ambient temperature being too high. The predefined conditions may include the temperature of the battery pack 12 being too high and/or the state of charge of the battery pack 12 being too low. The respective high and low thresholds may be set based on the application at hand.

If the hygrometer data is below the predetermined threshold (block 104=NO), the method 100 proceeds to block 108, where the control unit 30 determines whether a reconditioning timer 38 is in progress. If the reconditioning timer 38 is in progress (block 108=YES), the method 100 advances to block 106, as shown in FIG. 3.

Per block 106, if the predefined conditions for reconditioning have not been met (block 106=NO), the method 100 proceeds to block 110. If the reconditioning timer 38 is in progress (block 108=NO), the method 100 advances to block 110 as well. In block 110, the control unit 30 ensures that the heating element 28 is turned OFF and the dehumidification unit 22 is in the collection phase of dehumidification. In the collection phase, the exterior louver is in a closed state and the interior louver is in an open state. From block 110, the method 100 loops back to block 102, as indicated by line 116.

If the predefined conditions for reconditioning have been met (block 106=YES), the method 100 proceeds to block 112, where the control unit 30 determines whether the reconditioning timer 38 is in progress. Per block 112, if the reconditioning timer 38 is not in progress (block 112=NO), the method 100 advances to block 114, where the control unit 30 is adapted to begin the reconditioning timer 38 and turn the heating element 28 to an ON state, thereby executing the reconditioning phase of the dehumidification. From block 114, the method 100 loops back to block 102. If the reconditioning timer 38 is not in progress (block 112=YES), the method 100 loops back to block 102.

Referring to FIG. 1, the vehicle 14 may include a telematics module 72 for establishing two-way communications between the control unit 30 and a remotely located cloud computing service 70. The cloud computing service 70 may include one or more remote servers hosted on the Internet to store, manage, and process data. The cloud computing service 70 may be at least partially managed by personnel at various locations. The telematics module 72 may collect data from the battery pack 12 and telemetry data, such as location, speed, engine data, maintenance requirements and servicing, by interfacing with various internal sub-systems. The telematics module 72 may enable vehicle-to-vehicle (V2V) communication and/or a vehicle-to-everything (V2X) communication.

The system 10 may employ a wireless network 74 for communications between the vehicle 14 and the cloud computing service 70, shown in FIG. 1. The wireless network 74 may be a short-range network or a long-range network. The wireless network 74 may be a communication BUS, which may be in the form of a serial Control unit Area Network (CAN-BUS).

The wireless network 74 may be a serial communication bus in the form of a local area network. The local area network may include, but is not limited to, a Control unit Area Network (CAN), a Control unit Area Network with Flexible Data Rate (CAN-FD), Ethernet, Bluetooth, WIFI and other forms of data. The wireless network 74 may be a Wireless Local Area Network (LAN) which links multiple devices using a wireless distribution method, a Wireless Metropolitan Area Network (MAN) which connects several wireless LANs or a Wireless Wide Area Network (WAN) which covers large areas such as neighboring towns and cities. Other types of network technologies or communication protocols available to those skilled in the art may be employed.

In summary, an effective way of managing dehumidification in a rechargeable energy storage unit 12 is disclosed. In summary, the desiccant 26 is adapted to collect moisture from within the casing 18 during a collection phase of dehumidification. The heating element 28 is adapted to dry the desiccant 26 during a reconditioning phase of the dehumidification. The system 10 adds a breathable venting system that allows water vapor to be expelled while keeping liquids and debris from entering the battery casing 18. The advantage of the system 10 is that the trapped moisture inside a battery pack 12 may be gradually and systematically removed, thereby preventing issues due to condensation.

The control unit 30 of FIG. 1 includes a computer-readable medium (also referred to as a processor-readable medium), including a non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which may constitute a main memory. Such instructions may be transmitted by one or more transmission media, including coaxial cables, copper wire and fiber optics, including the wires that comprise a system bus coupled to a processor of a computer. Some forms of computer-readable media include, for example, a floppy disk, a flexible disk, hard disk, magnetic tape, other magnetic medium, a CD-ROM, DVD, other optical medium, a physical medium with patterns of holes, a RAM, a PROM, an EPROM, a FLASH-EEPROM, other memory chip or cartridge, or other medium from which a computer may read.

Look-up tables, databases, data repositories or other data stores described herein may include various kinds of mechanisms for storing, accessing, and retrieving various kinds of data, including a hierarchical database, a group of files in a file rechargeable energy storage system, an application database in a proprietary format, a relational database energy management system (RDBMS), etc. Each such data store may be included within a computing device employing a computer operating system such as one of those mentioned above and may be accessed via a network in one or more of a variety of manners. A file system may be accessible from a computer operating system and may include files stored in various formats. An RDBMS may employ the Structured Query Language (SQL) in addition to a language for creating, storing, editing, and executing stored procedures, such as the PL/SQL language mentioned above.

The flowcharts illustrate an architecture, functionality, and operation of possible implementations of systems, methods, and computer program products of various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by specific purpose hardware-based storage systems that perform the specified functions or acts, or combinations of specific purpose hardware and computer instructions. These computer program instructions may also be stored in a computer-readable medium that may direct a control unit or other programmable data processing apparatus to function in a particular manner, such that the instructions stored in the computer-readable medium produce an article of manufacture including instructions to implement the function/act specified in the flowchart and/or block diagram blocks.

The numerical values of parameters (e.g., of quantities or conditions) in this specification, including the appended claims, are to be understood as being modified in each respective instance by the term “about” whether or not “about” actually appears before the numerical value. “About” indicates that the stated numerical value allows some slight imprecision (with some approach to exactness in the value; about or reasonably close to the value; nearly). If the imprecision provided by “about” is not otherwise understood in the art with this ordinary meaning, then “about” as used here indicates at least variations that may arise from ordinary methods of measuring and using such parameters. In addition, disclosure of ranges includes disclosure of each value and further divided ranges within the entire range. Each value within a range and the endpoints of a range are hereby disclosed as separate embodiments.

The detailed description and the drawings or FIGS. are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings, or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework of the scope of the appended claims.

What is claimed is:

1. A system for managing dehumidification in a battery pack having a plurality of battery modules, the system comprising:
a casing adapted to house the plurality of battery modules, the casing having at least one cavity;
a dehumidification unit at least partially positioned within the at least one cavity, the dehumidification unit including a desiccant;
a heating element positioned in proximity to and adapted to selectively heat the desiccant;
a control unit having a processor and tangible, non-transitory memory on which instructions are recorded, the control unit being adapted to activate and/or control the heating element; and
wherein the desiccant is adapted to collect moisture within the casing during a collection phase of dehumidification and the heating element is adapted to dry the desiccant during a reconditioning phase of the dehumidification.

2. The system of claim 1, wherein the desiccant is composed of silica gel.

3. The system of claim 1, further comprising:
an internal hygrometer adapted to obtain hygrometer data pertaining to humidity level inside the casing; and
wherein the control unit is adapted to activate the heating element when a plurality of conditions is met, including the hygrometer data being at or above a respective threshold.

4. The system of claim 3, wherein the plurality of conditions includes an ambient temperature being above the respective threshold.

5. The system of claim 3, wherein the plurality of conditions includes a temperature of the battery pack being above the respective threshold and/or a state of charge of the battery pack being below the respective threshold.

6. The system of claim 1, further comprising:
an external hygrometer positioned outside the casing; and
wherein the control unit is adapted to adjust respective parameters of the heating element based on data obtained by the external hygrometer.

7. The system of claim 1, further comprising:
an interior vent cover and an exterior vent cover located at an interior end and an exterior end, respectively, of the at least one cavity; and
wherein the interior vent cover and the exterior vent respectively include a plurality of spaced apart gaps.

8. The system of claim 7, further comprising:
an internal louver located between the desiccant and the interior vent cover;
an external louver located between the desiccant and the exterior vent cover, the internal louver and the external louver having a respective closed state and a respective open state; and
wherein the internal louver is actuated to the respective closed state during the reconditioning phase and the external louver is actuated to the respective closed state during the collection phase.

9. The system of claim 8, further comprising:
a breathable membrane positioned between the exterior vent cover and the desiccant; and
wherein the breathable membrane is configured to permit water vapor to escape from the casing and prevent liquid from entering the casing.

10. The system of claim 8, wherein the external louver and the internal louver are configured to be actuated through a diffusion gradient.

11. The system of claim 8, wherein the external louver and the internal louver are driven by a single actuator, the external louver and the internal louver being configured to move in unison.

12. The system of claim 11, wherein the single actuator includes a piezo-electric actuated diaphragm and/or an active solenoid.

13. A method of managing dehumidification in a battery pack having a plurality of battery modules and a control unit with a processor and tangible, non-transitory memory on which instructions are recorded, the method comprising:
housing the plurality of battery modules in a casing with at least one cavity;
positioning a dehumidification unit within the at least one cavity, the dehumidification unit including a desiccant;
positioning a heating element in proximity to the desiccant and selectively heating the desiccant via the heating element, the heating element being adjustable via the control unit; and
collecting moisture from the plurality of battery modules in the desiccant during a collection phase of dehumidification and drying out the desiccant during a reconditioning phase of the dehumidification, via the heating element.

14. The method of claim 13, further comprising:
positioning an internal hygrometer inside the casing and obtaining hygrometer data pertaining to humidity level inside the casing, via the internal hygrometer; and
activating the heating element when a plurality of conditions is met, including the hygrometer data being at or above a respective threshold, via the control unit.

15. The method of claim 14, wherein the plurality of conditions includes an ambient temperature being above the respective threshold, a temperature of the battery pack being above the respective threshold and a state of charge of the battery pack being below the respective threshold.

16. The method of claim 15, further comprising:
positioning an interior vent cover and an exterior vent cover at an interior end and an exterior end, respectively, of the at least one cavity, an interior vent cover and an exterior vent cover having a plurality of spaced apart gaps; and
placing a breathable membrane between the exterior vent cover and the desiccant, the breathable membrane being configured to permit water vapor to escape from the casing and prevent liquid from entering the casing.

17. The method of claim 16, further comprising:
placing an internal louver between the desiccant and the interior vent cover;
placing an external louver between the desiccant and the exterior vent cover, the internal louver and the external louver having a respective closed state and a respective open state; and
actuating the internal louver to the respective closed state during the reconditioning phase and actuating the external louver to the respective closed state during the collection phase.

18. A system for managing dehumidification in a battery pack having a plurality of battery modules, the system comprising:
a casing adapted to house the plurality of battery modules, the casing having at least one cavity;
a dehumidification unit at least partially positioned within the at least one cavity, the dehumidification unit including a desiccant;
a heating element adapted to selectively heat the desiccant;
an internal hygrometer adapted to obtain data pertaining to humidity level inside the casing;
a control unit having a processor and tangible, non-transitory memory on which instructions are recorded, the control unit being adapted to activate and/or adjust the heating element based on the data obtained by the internal hygrometer;
an interior vent cover and an exterior vent cover located at an interior end and an exterior end, respectively, of the at least one cavity;
an internal louver located between the desiccant and the interior vent cover;
an external louver located between the desiccant and the exterior vent cover, the internal louver and the external louver having a respective closed state and a respective open state;
wherein the desiccant is adapted to collect moisture within the casing during a collection phase of dehumidification and the heating element is adapted to dry the desiccant during a reconditioning phase of the dehumidification; and
wherein the internal louver is actuated to the respective closed state during the reconditioning phase and the external louver is actuated to the respective closed state during the collection phase.

19. The system of claim 18, wherein the external louver and the internal louver are driven by a single actuator, the external louver and the internal louver being configured to move in unison.

20. The system of claim 19, further comprising:
a breathable membrane positioned between the exterior vent cover and the desiccant; and
wherein the breathable membrane is configured to permit water vapor to escape from the casing and prevent liquid from entering the casing.
